(19) United States
(12) Patent Application Publication
(10) Pub. No.: US 2013/0076222 A1
(43) Pub. Date: Mar. 28, 2013

(54) REFRIGERATOR

(71) Applicants: Gang U LEE, Daejeon (KR); Jong Hoon Oh, Gwangju (KR); Jee Hoon Lee, Goyang-si (KR); Sang Gyu Jung, Gwangju-si (KR)

(72) Inventors: Gang U LEE, Daejeon (KR); Jong Hoon Oh, Gwangju (KR); Jee Hoon Lee, Goyang-si (KR); Sang Gyu Jung, Gwangju-si (KR)

(73) Assignee: SAMSUNG ELECTRONICS CO., LTD., Suwon (KR)

(21) Appl. No.: 13/611,689

(22) Filed: Sep. 12, 2012

(30) Foreign Application Priority Data
Sep. 26, 2011 (KR) 10-2011-0096904

(51) Int. Cl. F25D 23/02; E05D 7/04

(52) U.S. Cl. 312/405; 16/248

(57) ABSTRACT

A refrigerator provided with a door having the height thereof easily adjustable, the refrigerator including a hinge bracket configured to connect a body to a door of the refrigerator, a hinge shaft coupled to the hinge bracket so as to enable ascending and descending, and a door support on which a lower surface of the door is placed, wherein the hinge shaft includes a shaft adjusting part formed at an upper side of the hinge bracket to easily rotate the hinge shift. A user allows the hinge shaft and the door support by rotating the shaft adjusting part, thereby adjusting the door supported by the door support.

### CROSS-REFERENCE TO RELATED APPLICATIONS

This application claims the priority benefit of Korean Patent Application No. 10-2011-0096904, filed on Sep. 26, 2011 in the Korean Intellectual Property Office, the disclosure of which is incorporated herein by reference.

### BACKGROUND

1. Field

Embodiments of the present disclosure relate to a refrigerator provided with a door having a height thereof adjustable.

2. Description of the Related Art

In general, a refrigerator is an apparatus which is provided with a storage compartment configured to store foods and a cool air supply apparatus configured to supply the storage compartment with a cool air, thereby keeping foods fresh. A front surface of the storage compartment is configured to be open such that the foods are inserted or withdrawn, and the open front surface is closed by a door that is rotatably coupled to a body of the refrigerator.

Such a door is coupled to the body by an upper hinge module and a lower hinge module. However, due to errors in manufacturing or assembly process, the door may happen to be disposed at an incorrect height. In this case, the aesthetic quality of the refrigerator is degraded, and further, the door may erroneously operate.

Accordingly, a refrigerator having a height-adjustable door is developed. An example of such a refrigerator is disclosed in the Korean Patent Publication No. 10-2008-0094778 and in the Korean Patent Publication No. 10-2008-0050137.

According to the publications, a hinge module is configured such that a hinge shaft ascends and descends with respect to a hinge bracket and the height of the door is adjusted by rotating the hinge shaft.

However, when rotating a hinge shaft, a tool is coupled at a lower end portion of the hinge shaft to rotate the tool, thereby having a complicacy in rotating the hinge shaft.

### SUMMARY

Therefore, it is an aspect of the present disclosure to provide a refrigerator allowing the height of a door to be easily adjusted.

It is another aspect of the present disclosure to provide a refrigerator capable of improving the workability in adjusting the height of the door.

Additional aspects of the disclosure will be set forth in part in the description which follows and, in part, will be apparent from the description, or may be learned by practice of the disclosure.

In accordance with an aspect of the present disclosure, a refrigerator including a body, a storage compartment, a door, a hinge bracket, a hinge shaft, a door support and a nut. The storage compartment is formed inside the body. The door is rotatably coupled to the body to open and close a front surface of the storage compartment that is open. The hinge bracket is provided with a fixing part coupled to the body and an extension part disposed at a lower side of the door. The hinge shaft is coupled to the extension part as to enable ascent or descent. The door support has a cam part comprising a plurality of cams and a stopper part configured to limit a height of the hinge shaft ascending or descending. The nut is coupled to a lower end of the hinge shaft such that the hinge shaft is fixed to the hinge bracket. The hinge shaft includes a screw thread part having a screw thread and a shaft adjusting part that is provided at a upper side of the screw thread part to rotate the hinge shaft. The door support is supported by the shaft adjusting part. The hinge shaft and the door support ascend as the shaft adjusting part is rotated.

The shaft adjusting part radially extends from a center part of the hinge shaft while being integrally formed with the hinge shaft.

The shaft adjusting part has a polygonal cross section.

The shaft adjusting part is disposed at an upper side of the extension part.

A tool is coupled to the shaft adjusting part to rotate the shaft adjusting part.

The stopper part includes a protrusion part that passes through a fixing hole formed at the extension part; and an interference member that is coupled to a lower surface of the protrusion part and interferes with the fixing hole.

The interference member is detachably coupled to the lower surface of the protrusion part.

The interference member includes a screw having a head part that interferes with the fixing hole.

A spring washer is coupled between the nut and the extension part to prevent the nut from being unfastened.

The fixing part is fixedly coupled to a lower surface of the body.

The door includes a left side door and a right side door.

The extension part includes a hinge hole allowing the hinge shaft to pass therethrough and the fixing hole allowing the stopper part to pass therethrough. Each of the hinge hole and the fixing hole is provided in plurality.

The nut coupled at the lower end of the hinge shaft is unfastened and the shaft adjusting part is rotated such that the hinge shaft and the door support ascend, thereby adjusting the height of the door, and the nut is coupled at the lower end of the hinge shaft to fix the hinge shaft and the door support.

In accordance with another aspect of the present disclosure, a refrigerator includes a body, a storage compartment, a door, a hinge bracket, a hinge shaft, a door support and a nut. The storage compartment is formed inside the body. The door is rotatably coupled to the body to open and close a front surface of the storage compartment that is open. The hinge bracket is provided with a fixing part coupled to the body and with an extension part disposed at a lower side of the door. The hinge shaft is coupled to the extension part as to enable ascent or descent. The door support has a cam part including a plurality of cams and a stopper part configured to limit a height of the hinge shaft ascending or descending. The nut is coupled to a lower end of the hinge shaft to fix the hinge shaft to the hinge bracket. The hinge shaft includes a shaft adjusting part disposed between the extension part and the door support to rotate the hinge shaft. The hinge shaft and the door support ascend or descend as the shaft adjusting part is rotated.

In accordance with another aspect of the present disclosure, a lower hinge module, which is configured to hingedly couple a door of a refrigerator to a body of the refrigerator includes a hinge bracket, a hinge shaft, a door support and a nut. The hinge bracket is provided with a fixing part coupled to the body and with an extension part disposed at a lower side of the door. The hinge shaft is coupled to the extension part as to enable ascent or descent. The door support has a cam part including a plurality of cams and a stopper part configured to limit a height of the hinge shaft ascending or descending. The nut is coupled at a lower end of the hinge shaft to fix the hinge shaft to the hinge bracket. The hinge shaft includes a screw thread part having a screw thread and a shaft adjusting part that is provided at an upper side of the screw thread part to rotate the hinge shaft. The door support is supported by the shaft adjusting part. The hinge shaft and the door support ascend and descend as the shaft adjusting part is rotated.

According to the refrigerator of the embodiment of the present disclosure, a shaft adjusting part configured to rotate a hinge shaft is disposed at an upper side of the hinge bracket, thereby facilitating an access to the shaft adjusting part and thus improving the workability in adjusting the height of the door.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating an exterior of a refrigerator having a door open according to an embodiment of the present disclosure.

FIG. 2 is an enlarged view illustrating a lower hinge module of the refrigerator of FIG. 1.

FIG. 3 is a side view illustrating the lower hinge module of the refrigerator of FIG. 1.

FIG. 4 is a side view illustrating a hinge shaft and a door support of the refrigerator of FIG. 1 being adjusted at height.

FIG. 5 is a view illustrating a state of a nut, which is coupled at a lower end of the hinge shaft, being separated from the hinge shaft such that the height of a door of the refrigerator of FIG. 1 is adjusted.

FIG. 6 is a view illustrating a state of coupling a tool to a shaft adjusting part of the hinge shaft and rotating the hinge shaft to adjust the height of the door.

### DETAILED DESCRIPTION

Reference will now be made in detail to the embodiments of the present disclosure, examples of which are illustrated in the accompanying drawings, wherein like reference numerals refer to like elements throughout.

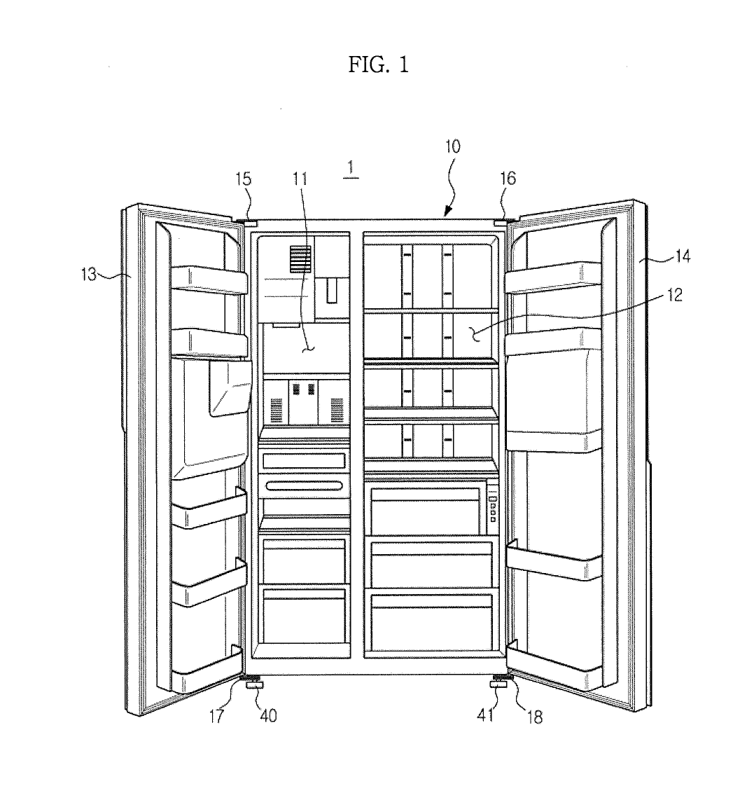

FIG. 1 is a view illustrating an exterior of a refrigerator having a door open according to an embodiment of the present disclosure.

Referring to FIG. 1, a refrigerator 1 according to an embodiment of the present disclosure includes a body 10; storage compartments 11 and 12 formed inside the body 10; doors 13 and 14 coupled to the body 10 to open and close a front surface of the storage compartments 11 and 12 that is open; and a cooling apparatus (not shown) configured to supply the storage compartments 11 and 12 with cool air.

The body 10 includes an inner case forming the storage compartments 11 and 12, an outer case coupled at an outer side of the inner case while forming an external appearance of the refrigerator 1, and an insulating material foamed between the inner case and the outer case to thermally insulate the storage compartments 11 and 12.

The cooling apparatus includes a compressor, a condenser, an expansion valve, an evaporator, a blower fan, and a cool air duct. As a refrigerant is vaporized by absorbing a surrounding heat, the cooling apparatus supplies the storage compartments 11 and 12 with cool air.

The front surface of the storage compartments 11 and 12 is configured to be open to input or withdraw foods with respect to the storage compartments 11 and 12. The doors 13 and 14 are rotatably coupled to the body 10 through upper hinge modules 15 and 16 and lower hinge modules 17 and 18. Legs 40 and 41 are coupled to the lower hinge modules 17 and 18 to support the refrigerator 1 against the floor.

Embodiments of the present disclosure may not only be applied to a double-door refrigerator having two rotatably doors 13 and 14 as shown in the drawing but also be applied to a single-door refrigerator having only one door.

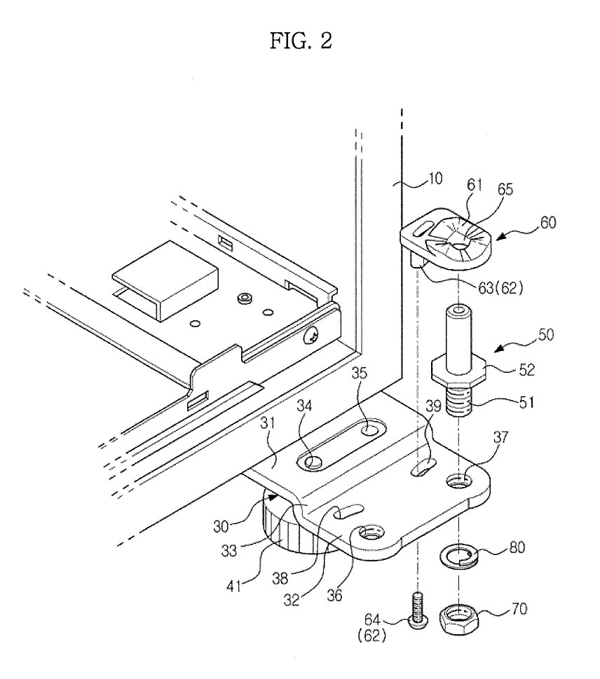

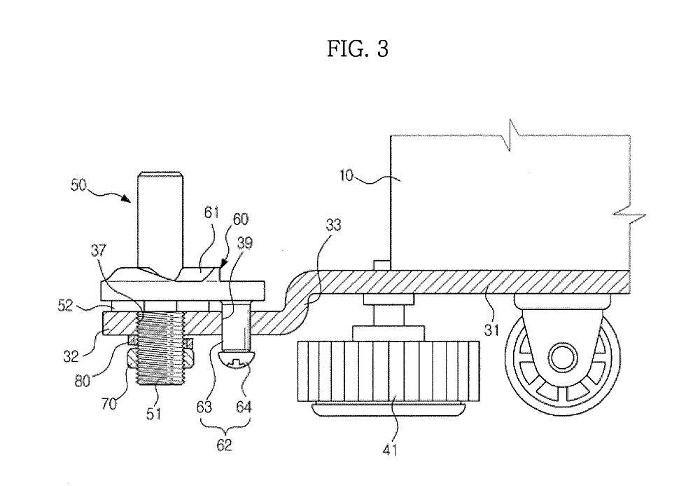

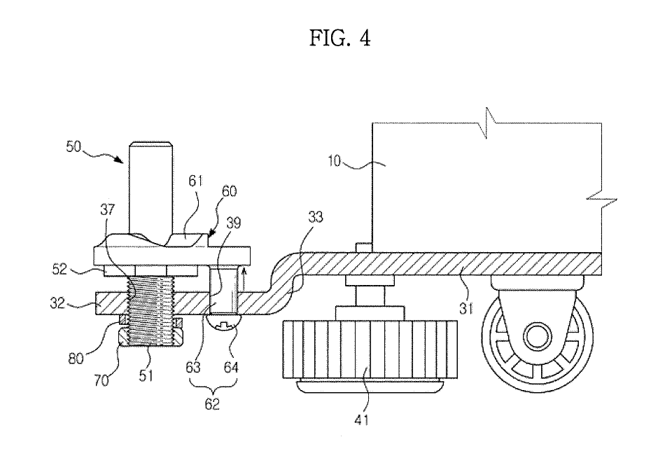

FIG. 2 is an enlarged view illustrating a lower hinge module of the refrigerator of FIG. 1. FIG. 3 is a side view illustrating the lower hinge module of the refrigerator of FIG. 1. FIG. 4 is a side view illustrating a hinge shaft and a door support of the refrigerator of FIG. 1 after the height of a door is adjusted.

Referring to FIGS. 2 and 4, the lower hinge module includes a hinge bracket 30 connecting the body 10 to the door, a hinge shaft 50 serving as a rotary shaft of the door and coupled to the hinge bracket 30 as to enable an ascent or a descent, and a door support 60 on which a lower surface of the door is placed and which is coupled to the hinge shaft 50 as to enable an ascent or a descent together with the hinge shaft 50.

The hinge bracket 30 includes a fixing part 31 having a portion fixedly coupled to a lower surface of the body 10 and an extension part 32 extending from the fixing part 31 forward to be disposed at the lower surface of the door. The fixing part 31 and the extension part 32 are formed to be parallel to the ground, and an inclined part 33 is formed between the fixing part 31 and the extension part 32 such that the extension part 32 is disposed lower than the fixing part 31.

The hinge bracket 30 needs to have a strength suitable for supporting the door, and is formed using metal as an integral body.

The fixing part 31 has leg coupling holes 34 and 35 to which the leg 41 supported against the floor is coupled. The hinge bracket 30 has a plurality of coupling holes 34 and 35 for both of the left side door and the right side door.

In addition, the extension part 32 of the hinge bracket 30 has hinge shaft coupling holes 36 and 37 to which the hinge shaft 50 is coupled and stopper coupling holes 38 and 39 to which a stopper part 62, which is to be described later, is coupled. The hinge shaft coupling holes 36 and 37 are provided in plurality, and the stopper part coupling holes 38 and 39 are provided in plurality to be used for both of the left side door and the right side door.

The hinge shaft 50 serves as a rotation shaft of the door. The door is provided at a lower portion thereof with a hinge shaft insertion groove (not shown) to which an upper portion of the hinge shaft 50 is inserted. A screw thread part 51 provided at an outer surface thereof with a screw thread is formed at a lower portion of the hinge shaft 50. The screw thread part 51 enables the hinge shaft 50 to be screwed to the extension part 32 of the hinge bracket 30 while interacting with a screw thread formed on an inner surface of the hinge shaft coupling holes 36 and 37. Accordingly, the hinge shaft 50 moves up and down while rotating.

In order to rotate the hinge shaft 50, a shaft adjusting part 52 is formed at a middle portion of the hinge shaft 50, that is, at an upper side of the screw thread part 51, while radially protruding from a center of the hinge shaft 50.

The shaft adjusting part 52 has a predetermined thickness suitable for being coupled to a tool such as a spanner, and has a polygonal cross section, for example, hexagonal cross section. Such a shaft adjusting part 52 is integrally formed with the hinge shaft 50 such that the hinge shaft 50 is rotated according to rotation of the shaft adjusting part 52.

That is, when the shaft adjusting part 52 of the hinge shaft 50 is rotated, the screw thread of the screw thread part 51 interacts with the screw thread of the hinge shaft coupling holes 36 and 37, so that the hinge shaft 50 moves up and down. The shaft adjusting part 52 is provided in a predetermined shape and size that allows the shaft adjusting part 52 to interfere with the hinge shaft coupling holes 36 and 37 without passing through the hinge shaft coupling holes 36 and 37.

The door support 60 serves to support the door while coming into a close contact with the lower surface of the door, and includes a cam part 61 configured to automatically open and close the door. The cam part 51 is provided at an upper surface with a lower cam that is slantly formed, and with an upper cam disposed at the lower surface of the door. The upper cam and the lower cam, if the door is open by a predetermined angle or above, applies a force to a direction of opening the door, and if the door is closed by a predetermined angle or below, applies a force to a direction of closing the door through interaction between the upper cam and the lower cam.

The door support 60 is provided at the center with a hole 65 through which the hinge shaft 50 passes through. Accordingly, the hinge shaft 50 passes through the door support 60 via the hole 65. In addition, the door support 60 is disposed at an upper side of the shaft adjusting part 52 while being substantially supported by the shaft adjusting part 52.

That is, the door support 60 is influenced by a lower direction force by a self weight, and thus supported by the shaft adjusting part 52 of the hinge shaft 50. In this case, if the shaft adjusting part 52 ascends, the door support 60 also ascends while being pressed by the shaft adjusting part 52. Accordingly, the door support 60 ascends or descends together with the shaft adjusting part 52.

Herein, the shaft adjusting part 52 of the hinge shaft 50 is provided in a predetermined size and shape that allows the shaft adjusting part 52 to interfere with the hole 65 of the door support 60 without passing through the hole 65.

Meanwhile, the door support 60 includes the stopper part 62 that is configured to a limit a maximum height of the door support 60 such that the door support 60 moves within a predetermined range. Referring to FIGS. 3 and 4, the stopper part 62 includes a protrusion part 63, which passes through the stopper part coupling holes 38 and 39, and a interference member 64 that is coupled to a lower surface of the protrusion part 63. The interference member 64 may be a screw, for example.

The interference member 64 is provided to interfere with the screw part coupling holes 38 and 39 formed through the extension part 32 to prevent the door support 60 from being separated from the hinge bracket 30, that is, to limit the height of door support 60 ascending, thereby limiting the maximum height of the door adjustable.

Meanwhile, after the height of the door is adjusted, a nut 70 is coupled to a lower end of the hinge shaft 50 to fix the hinge shaft 50 to the hinge bracket 30. In order to prevent the nut 70 from being unfastened, a washer 80 is coupled between the nut 70 and the hinge bracket 30. The washer 80 may be implemented using a spring washer that allows a rotation in one direction while restraining a rotation in the opposite direction.

According to this structure, the hinge shaft 50 easily moves up and down according to rotation of the shaft adjusting part 52, and the door support 60 supported by the upper surface of the shaft adjusting part 53 moves up and down together with the shaft adjusting part 52, and in turn, the door supported by the door support moves up and down.

In addition, the nut 70, after the height of the door is adjusted, is coupled at the lower end of the hinge shaft 50, and the washer 80 is coupled to prevent the nut 70 from being unfastened, so that the door is not deflected after a long term use.

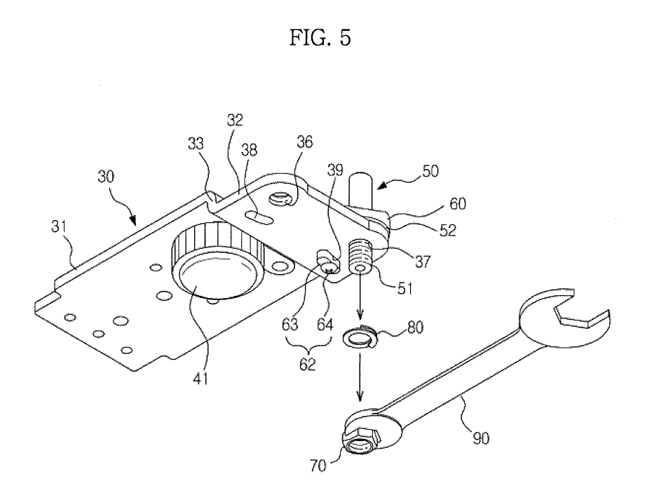

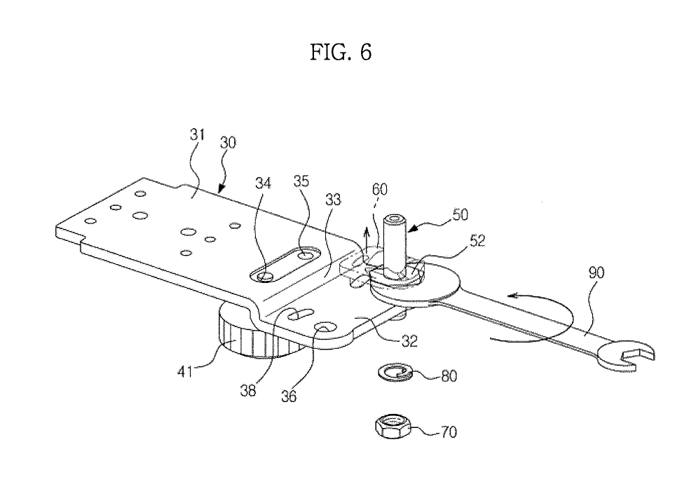

FIG. 5 is a view illustrating a state of a nut, which is coupled at a lower end of the hinge shaft, being separated from the hinge shaft such that the height of a door of the refrigerator of FIG. 1 is adjusted. FIG. 6 is a view illustrating a state of coupling a tool to the shaft adjusting part of the hinge shaft and rotating the hinge shaft such that the height of the door is adjusted.

Hereinafter, a scheme of adjusting the height of the door of the refrigerator according to the embodiment of the present disclosure will be further described with reference to FIGS. 5 and 6. Since the configuration has been described above, detailed description of the configuration will be omitted.

Referring to FIG. 5, in order to adjust the height of the door, the nut 70 coupled at the lower end of the hinge shaft 50 is unfastened from the hinge shaft 50 by use of a tool such as spanner 90.

Thereafter, referring to FIG. 6, the tool such as the spanner 90 is coupled to the shaft adjusting part 52 of the hinge shaft 50 and rotates the hinge shaft 50 in a state of being coupled to the shaft adjusting part 52. The shaft adjusting part 52 and the hinge shaft 50 move up and down while rotating, and the door support 60 supported by the shaft adjusting part 52 also moves up and down together with the shaft adjusting part 52. Accordingly, the height of the door supported by the door support 60 is adjusted.

In this case, the shaft adjusting part 52 is disposed at an upper side of the hinge bracket 30, thereby facilitating an approaching of a tool, such as the spanner 90, and a rotating of the shaft adjusting part 52.

After the height of the door is adjusted, the washer 80 is coupled to the nut 70 at the lower end of the hinge shaft 50, so that the hinge shaft 50 and the door are fixed at the adjusted heights for a long period time.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A refrigerator comprising:
a body;
a storage compartment formed inside the body;
a door rotatably coupled to the body to open and close a front surface of the storage compartment that is open;
a hinge bracket provided with a fixing part coupled to the body and with an extension part disposed at a lower side of the door;
a hinge shaft coupled to the extension part as to enable ascent or descent;
a door support having a cam part comprising a plurality of cams and a stopper part configured to limit a height of the hinge shaft ascending or descending; and
a nut coupled to a lower end of the hinge shaft such that the hinge shaft is fixed to the hinge bracket,
wherein the hinge shaft comprises a screw thread part having a screw thread and a shaft adjusting part that is provided at a upper side of the screw thread part to rotate the hinge shaft, and the door support is supported by the shaft adjusting part, and
wherein the hinge shaft and the door support ascend and descend as the shaft adjusting part is rotated.

2. The refrigerator of claim 1, wherein the shaft adjusting part radially extends from a center part of the hinge shaft while being integrally formed with the hinge shaft.

3. The refrigerator of claim 1, wherein the shaft adjusting part has a polygonal cross section.

4. The refrigerator of claim 1, wherein the shaft adjusting part is disposed at an upper side of the extension part.

5. The refrigerator of claim 1, wherein a tool is coupled to the shaft adjusting part to rotate the shaft adjusting part.

6. The refrigerator of claim 1, wherein the stopper part comprises: a protrusion part that passes through a fixing hole formed at the extension part; and an interference member that is coupled to a lower surface of the protrusion part and interferes with the fixing hole.

7. The refrigerator of claim 6, wherein the interference member is detachably coupled to the lower surface of the protrusion part.

8. The refrigerator of claim 6, wherein the interference member comprises a screw having a head part that interferes with the fixing hole.

9. The refrigerator of claim 1, wherein a spring washer is coupled between the nut and the extension part to prevent the nut from being unfastened.

10. The refrigerator of claim 1, wherein the fixing part is fixedly coupled to a lower surface of the body.

11. The refrigerator of claim 1, wherein the door comprises a left side door and a right side door.

12. The refrigerator of claim 1, wherein the extension part comprises a hinge hole allowing the hinge shaft to pass therethrough and the fixing hole allowing the stopper part to pass therethrough, and each of the hinge hole and the fixing hole is provided in plurality.

13. The refrigerator of claim 1, wherein the nut coupled at the lower end of the hinge shaft is unfastened and the shaft adjusting part is rotated such that the hinge shaft and the door support ascend or descend, thereby adjusting the height of the door, and wherein the nut is coupled at the lower end of the hinge shaft to fix the hinge shaft and the door support.

14. A refrigerator comprising:
a body;
a storage compartment formed inside the body;
a door rotatably coupled to the body to open and close a front surface of the storage compartment that is open;
a hinge bracket provided with a fixing part coupled to the body and with an extension part disposed at a lower side of the door;
a hinge shaft coupled to the extension part as to enable ascent or descent;
a door support having a cam part comprising a plurality of cams and a stopper part configured to limit a height of the hinge shaft ascending or descending; and
a nut coupled to a lower end of the hinge shaft to fix the hinge shaft to the hinge bracket,
wherein the hinge shaft comprises a shaft adjusting part disposed between the extension part and the door support to rotate the hinge shaft, and
wherein the hinge shaft and the door support ascend or descend as the shaft adjusting part is rotated.

15. A lower hinge module configured to hingedly couple a door of a refrigerator to a body of the refrigerator, the lower hinge module comprising:
a hinge bracket having a fixing part coupled to the body and an extension part disposed at a lower side of the door;
a hinge shaft coupled to the extension part as to enable ascent or descent;
a door support having a cam part comprising a plurality of cams and a stopper part configured to limit a height of the hinge shaft ascending or descending; and
a nut coupled at a lower end of the hinge shaft to fix the hinge shaft to the hinge bracket,
wherein the hinge shaft comprises a screw thread part having a screw thread and a shaft adjusting part that is provided at an upper side of the screw thread part to rotate the hinge shaft, and the door support is supported by the shaft adjusting part, and
wherein the hinge shaft and the door support ascend and descend as the shaft adjusting part is rotated.
